(19) United States
(12) Patent Application Publication
(10) Pub. No.: US 2009/0185475 A1
(43) Pub. Date: Jul. 23, 2009

(54) NON-ORTHOGONAL SUBCARRIER MAPPING METHOD AND SYSTEM

(76) Inventor: Hyung G. Myung, West New York, NJ (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/185,518

(22) Filed: Aug. 4, 2008

(30) Foreign Application Priority Data
Jan. 23, 2008 (US) PCT/US2008/051807

(51) Int. Cl. H04J 1/00

(52) U.S. Cl. 370/210

(57) ABSTRACT

A method and system of accommodating multiple users through non-orthogonal subcarrier mapping of a single carrier frequency division multiple access system in which input data to a transmitter is modulated via an N-point discrete Fourier transform (N-point DFT), non-orthogonal subcarrier mapping, M-point inverse discrete Fourier transform (M-point IDFT), and cyclic prefix (CP) insertion; the modulated data is transmitted to and received by a receiver; and the received data is demodulated for cyclic prefix (CP) removal, M-point discrete Fourier transform (M-point DFT), subcarrier demapping and equalization, and N-point inverse discrete Fourier transform (N-point IDFT).

### STATEMENT OF RELATED APPLICATIONS

This application claims the benefit of and priority on Patent Cooperation Treaty International Patent Application No. PCT/US2008/051807, filed on 23 Jan. 2008, which designates the United States of America.

### BACKGROUND OF THE INVENTION

1. Technical Field

The present invention is generally directed to a method and system to accommodate a non-orthogonal mapping scheme in a single carrier frequency division multiple access (SC-FDMA) system.

2. Related Art

Currently, several wireless communication standards use orthogonal frequency division multiplexing (OFDM) and orthogonal frequency division multiple access (OFDMA) to achieve high bit rates. In these approaches, a signal is “spread out” and distributed among subcarriers, which send portions of the signal in parallel. The subcarrier frequencies are chosen so that the modulated data streams are orthogonal to each other, such that cross-talk between the sub-channels is eliminated and inter-carrier guard bands are not required. The receiving end reassembles the portions that were sent in parallel. FIG. 1 is a flow chart of transmission and reception within an OFDMA system. OFDM and OFDMA systems suffer from a high peak-to-average power ratio (PAPR), a need for an adaptive or coded scheme to overcome spectral nulls in the channel, and high sensitivity to carrier frequency offset.

SC-FDMA overcomes some of the problems present in OFDM and OFDMA systems by performing a Fourier transform on the signal and then using subcarriers to send it through a serial transmission rather than in parallel. On reception of the transmission, an inverse Fourier transform is performed. FIG. 2 is flow chart of this process. Although SC-FDMA offers a lower PAPR than do OFDM and OFDMA, its effectiveness is limited by the choice of mapping scheme employed. Two approaches exist for SC-FDMA systems to apportion subcarriers among terminals. In localized SC-FDMA (LFDMA), each terminal uses a set of adjacent subcarriers to transmit its symbols. Thus, the bandwidth of a LFDMA transmission is confined to a fraction of the system bandwidth. LFDMA can potentially achieve multi-user diversity in the presence of frequency selective fading if it assigns each user to subcarriers in a portion of the signal band where that user has favorable transmission characteristics. The alternative approach is distributed SC-FDMA, wherein the subcarriers assigned to a terminal are spread over the entire signal band. This approach is robust against frequency selective fading because information is spread across the entire signal band. One realization of distributed SC-FDMA is interleaved FDMA (IFDMA) where occupied subcarriers are equidistant from each other.

FIG. 3 is a comparison of the two mapping schemes. In this figure, three terminals are present, each transmitting symbols on four subcarriers in a system with a total of twelve subcarriers. With LFDMA, terminal 1 uses subcarriers 0, 1, 2, and 3; in the distributed scheme, terminal 1 uses subcarriers 0, 3, 6, and 9.

This current SC-FDMA system only allocates an orthogonal set of subcarriers to each user so that the users do not interfere with each other. This allocation of non-overlapping orthogonal subcarriers limits the number of simultaneous users who can use the carrier frequency.

Accordingly, there is a need for a non-orthogonal subcarrier mapping which allows overlap among users and increases the number of users who can simultaneously use the carrier.

### BRIEF SUMMARY OF THE INVENTION

The present invention provides a method that accommodates non-orthogonal subcarrier mapping in a single carrier frequency division multiple access (SC-FDMA) system.

The first step in modulating the SC-FDMA subcarriers is to perform an N-point discrete Fourier transform (DFT) to produce a frequency domain representation of the input symbols. The transmitter then maps each of the N-point DFT outputs to one of the M (>N) subcarriers that can be transmitted. A typical value of M is 256 subcarriers. Unlike conventional SC-FDMA, the mapping in the present invention is a non-orthogonal mapping. This allows for more users to simultaneously use the same carrier but with increased risks of multi-user access interference. The result of the subcarrier mapping is a set of complex subcarrier amplitudes.

An M-point inverse DFT (IDFT) transforms the subcarrier amplitudes to a complex time domain signal. Each such complex time domain signal then modulates a single frequency carrier, and the modulated symbols are ultimately transmitted sequentially.

A receiver transforms the received signal into the frequency domain via M-point DFT, de-maps the subcarriers, and then performs the frequency domain equalization. This equalization is necessary to combat the intersymbol interference caused by the modulation using a single carrier. The equalized symbols are transformed back into the time domain via the N-point IDFT, and detection and decoding take place in the time domain.

Benefits of the new method over the old SC-FDMA method include an increased number of users utilizing the same carrier frequency.

### BRIEF DESCRIPTION OF THE DRAWINGS

The invention may be more completely understood in consideration of the following detailed description of various embodiments of the invention in connection with the accompanying drawings, which are as follows.

FIG. 1 is a flow chart of a prior art OFDMA system.

FIG. 2 is a flow chart of a prior art SC-FDMA system.

FIG. 3 is a comparison of the distributed mapping scheme and the localized mapping scheme for SC-FDMA systems.

FIG. 4 is a flow chart of a non-orthogonal SC-FDMA system according to the invention.

FIG. 5 is an application of the invention in a comparison with the prior art.

### DETAILED DESCRIPTION OF PREFERRED EMBODIMENTS

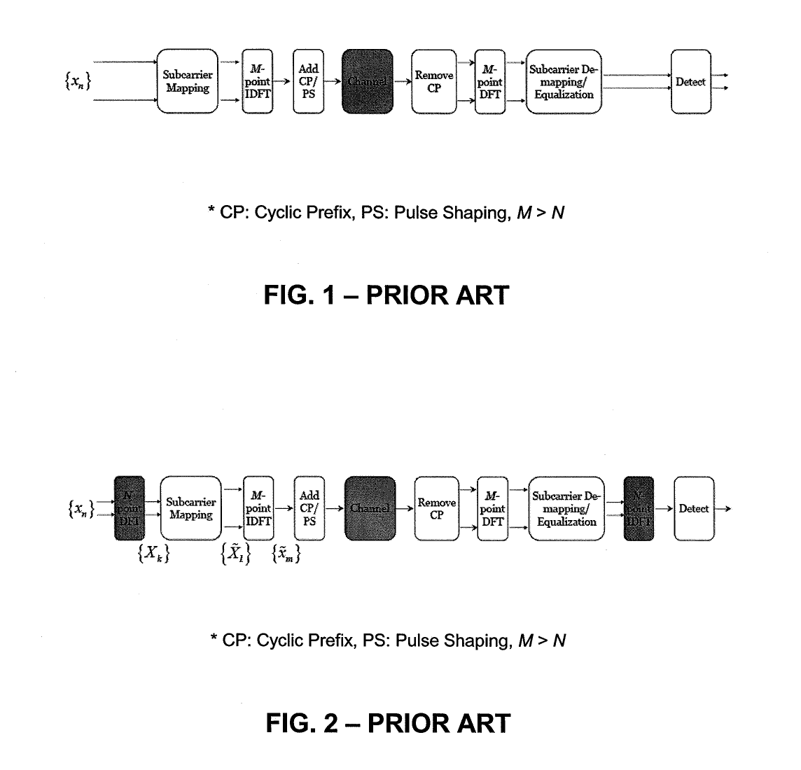

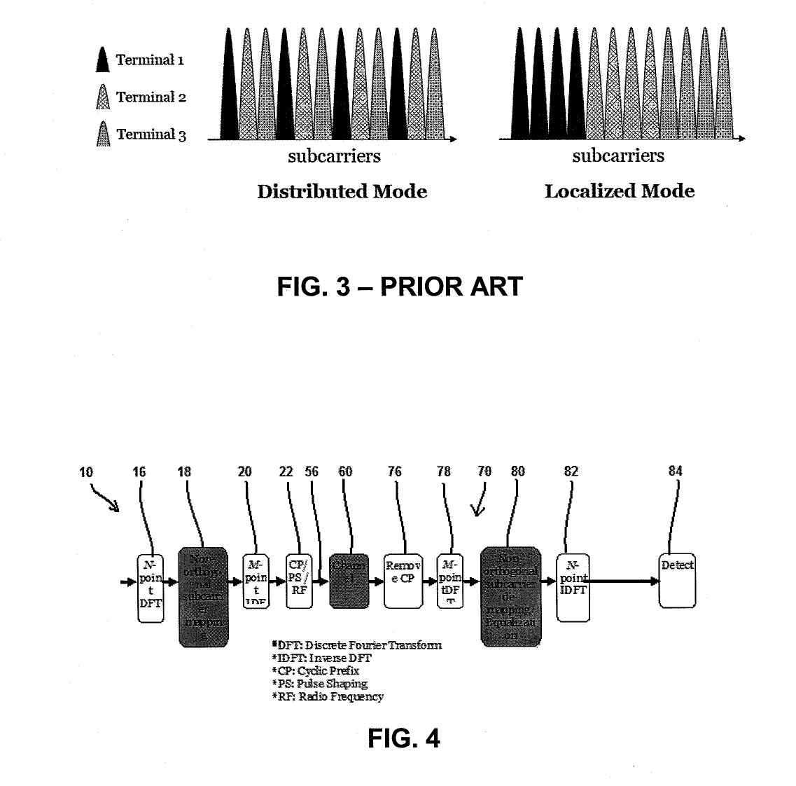

FIG. 1 is a flow chart of a prior art OFDMA system and FIG. 2 is a flow chart of a prior art SC-FDMA system for comparison purposes to the present invention. FIG. 3 is a comparison of the distributed mapping scheme and the localized mapping scheme for SC-FDMA systems.

FIG. 4 is a flow chart of an embodiment of the invention through a non-orthogonal SC-FDMA system. To begin the process, the transmitter 10 groups the modulation symbols, xₙ, into blocks, each of which contain N symbols. The transmitter 10 then begins the SC-FDMA modulation process by performing an N-point DFT 16 to produce a frequency domain representation of the input symbols. The transmitter 10 then maps each of the N-point DFT outputs using a non-orthogonal subcarrier mapping 18 to one of the M (>N) subcarriers that can be transmitted. The M-point IDFT 20 then transforms the subcarrier amplitudes to a complex time domain signal. Each such complex time domain signal then modulates a single frequency carrier, and the modulated symbols are ultimately transmitted sequentially.

The transmitter 10 can perform two other signal processing operations prior to transmission. It can insert a set of symbols referred to as a cyclic prefix (CP) insertion 22 in order to provide guard time to prevent inter-block interference (IBI) due to multipath propagation. It also can perform a linear filtering operation referred to as pulse shaping in order to reduce out-of-band signal energy. In general, CP is a copy of the last part of the block, which is added at the start of each block for multiple reasons. First, CP acts as a guard time between successive blocks. If the length of the CP is longer than the maximum delay spread of the channel, or roughly the length of the channel impulse response, then there is no IBI. Second, as CP is a copy of the last part of the block, it converts a discrete time linear convolution into a discrete time circular convolution. Thus, transmitted data propagating through the channel can be modeled as a circular convolution between the channel impulse response and the transmitted data block, which in the frequency domain is a point-wise multiplication of the DFT frequency samples. Then, to remove the channel distortion, the DFT of the received signal can simply be divided by the DFT of the channel impulse response point-wise, or a more sophisticated frequency domain equalization technique can be implemented.

The data or signal 54 exiting the transmitter 10 is transmitted as transmission data or signal 56 via channel 60.

A receiver 70 removes the CP 76 from the received transmission or data signal 56, transforms the signal 56 into the frequency domain via M-point DFT 78, and demaps the subcarriers 80. After demapping the subcarriers, the receiver 70 performs the frequency domain equalization. This equalization is necessary to combat the intersymbol interference caused by the modulation using a single carrier. The equalized symbols are transformed back into the time domain via the N-point IDFT 82 resulting in demodulized data 58.

The demodulized data 58 is detected 84 and decoded in the time domain.

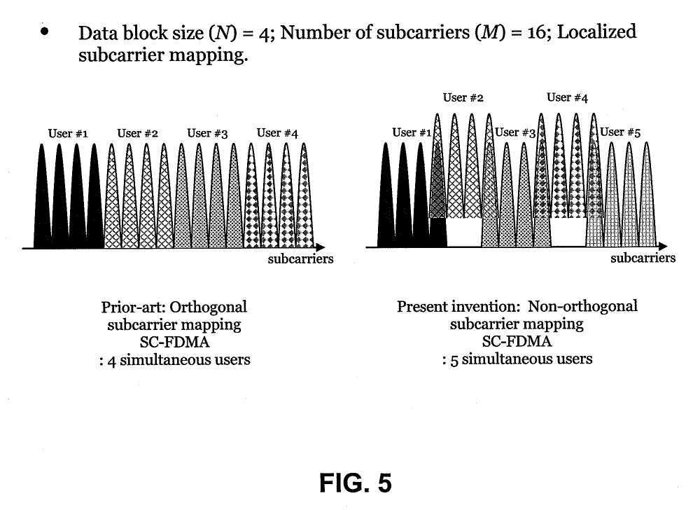

FIG. 5 is an application of the present non-orthogonal SC-FDMA system that compares it to the prior art orthogonal SC-FDMA. Both systems are illustrated with 16 subcarriers, a data block size (N) of four, and localized subcarrier mapping. With conventional orthogonal SC-FDMA, the carrier frequency can only accommodate four users. A system of the present invention with non-orthogonal subcarrier mapping can accommodate five users.

In a previous hybrid subcarrier mapping method invention by this inventor, there are two different user groups that use different types of conventional subcarrier mapping methods; one group uses distributed subcarrier mapping method and the other uses localized subcarrier mapping method. Users that have different subcarrier mapping may have overlapping subcarriers but the users are orthogonal in the code domain using orthogonal direct sequence code spreading. In the current invention, only localized subcarrier mapping method is considered in the system and the use of orthogonal direct sequence code spreading is not necessary. The users overlap in the parts of the subcarriers with other users, deliberately causing interference with each other. As result, the total number of simultaneous users increases compared to the conventional or hybrid subcarrier mapping for a given fixed number of allocated subcarriers per user.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A system for non-orthogonal subcarrier mapping of data, comprising:
a) a transmitter comprising modules or subroutines for N-point discrete Fourier transform (N-point DFT), non-orthogonal subcarrier mapping, M-point inverse discrete Fourier transform (M-point IDFT), and cyclic prefix (CP) insertion;
b) a receiver comprising modules or subroutines for cyclic prefix (CP) removal, M-point discrete Fourier transform (M-point DFT), subcarrier demapping and equalization, and N-point inverse discrete Fourier transform (N-point IDFT); and
c) at least one channel over which data is transmitted, wherein the input data acted upon by the transmitter is transmitted from the transmitter as transmission data via the at least one channel and is the received data that is received by the receiver.

2. The system as claimed in claim 1, wherein the system adapts the modulation format and the transmission bit rate to match current channel conditions.

3. The system as clamed in claim 2, wherein the transmitter modulates the input data by:
a) performing an N-point DFT to produce a frequency domain representation of the input symbols;
b) mapping each of the N-point DFT outputs to one of M (>N) subcarriers using non-orthogonal mapping;
c) performing an M-point IDFT to transform the subcarrier amplitudes to a complex time domain signal;
d) using each such complex time domain signal to modulate a single frequency carrier; and
e) transmitting the modulated symbols sequentially.

4. The system as claimed in claim 3, wherein the transmitter further:
a) inserts a set of symbols referred to as a cyclic prefix (CP) insertion in order to provide guard time to prevent inter-block interference (IBI) due to multipath propagation, wherein CP is a copy of the last part of the block, which is added at the start of each block; and
b) performs a linear filtering operation referred to as pulse shaping in order to reduce out-of-band signal energy.

5. The system as claimed in claim 4, wherein the transmitter demodulates the received data by:
a) removing the cyclic prefix (CP) from the received data signal;
b) transforming the received data signal into the frequency domain by performing an M-point DFT;
c) demapping the subcarriers;
d) performing a frequency domain equalization; and
e) transforming the equalized symbols back into the time domain by performing an N-point IDFT.

6. The system as claimed in claim 5, wherein the data is wireless broadband transmissions.

7. A method for transmitting and receiving data using non-orthogonal subcarrier mapping comprising the steps of:
a) in a transmitter:
i) performing an N-point DFT to produce a frequency domain representation of the input symbols;
ii) mapping each of the N-point DFT outputs to one of M (>N) subcarriers using non-orthogonal mapping;
iii) performing an M-point IDFT to transform the subcarrier amplitudes to a complex time domain signal;
iv) using each such complex time domain signal to modulate a single frequency carrier; and
v) transmitting the modulated symbols sequentially over at least one channel; and
b) in a receiver:
i) removing the cyclic prefix (CP) from the received data signal;
ii) transforming the received data signal into the frequency domain by performing an M-point DFT;
iii) demapping the subcarriers;
iv) performing a frequency domain equalization;
v) transforming the equalized symbols back into the time domain by performing an N-point IDFT.

8. The method as claimed in claim 7, further comprising the steps of:
a) inserting into the input data a set of symbols referred to as a cyclic prefix (CP) insertion in order to provide guard time to prevent inter-block interference (IBI) due to multipath propagation, wherein CP is a copy of the last part of the block, which is added at the start of each block; and
b) performing a linear filtering operation referred to as pulse shaping on the input data in order to reduce out-of-band signal energy.

9. The system as claimed in claim 8, wherein the data is wireless broadband transmissions.
